(19) United States
(12) Patent Application Publication
(10) Pub. No.: US 2015/0188394 A1
(43) Pub. Date: Jul. 2, 2015

(54) MOTOR ASSEMBLY

(71) Applicant: SAMSUNG ELECTRO-MECHANICS CO., LTD, Gyeonggi-Do (KR)

(72) Inventors: Yong Wan CHO, Gyeonggi-Do (KR); Hyun Taek AHN, Gyeonggi-Do (KR); Sang Ho SEO, Gyeonggi-Do (KR); Young Bok YOON, Gyeonggi-Do (KR); Jin Su SEOK, Gyeonggi-Do (KR)

(73) Assignee: SAMSUNG ELECTRO-MECHANICS CO., LTD., Gyeonggi-Do (KR)

(21) Appl. No.: 14/585,914

(22) Filed: Dec. 30, 2014

(30) Foreign Application Priority Data
Dec. 30, 2013 (KR) 10-2013-0167215

(51) Int. Cl. H02K 11/00

(52) U.S. Cl. CPC H02K 11/0073

(57) ABSTRACT

Embodiments of the invention provide a motor assembly including a terminal provided at a stator of a motor and electrically connected to a coil wound around the stator, and a controller formed with a coupling hole to which the terminal is coupled and electrically connected and controlling electric input and output to the terminal.

### CROSS REFERENCE TO RELATED APPLICATION

This application claims the benefit of and priority under 35 U.S.C. §119 to Korean Patent Application No. KR 10-2013-0167215, entitled “MOTOR ASSEMBLY,” filed on Dec. 30, 2013, which is hereby incorporated by reference in their entirety into this application.

### BACKGROUND

1. Field of the Invention

The present invention relates to a motor assembly.

2. Description of the Related Art

A general switched reluctance motor (SRM) is a motor in which both of a stator and a rotor have a magnetic structure, which is a salient pole, the stator has a concentrated type coil wound therearound, and the rotor is configured only of an iron core without any type of excitation device (e.g., a winding or a permanent magnet, as non-limiting examples), such that a competitive cost is excellent.

Particularly, a speed changeable switched reluctance motor stably generates a continuous torque with the aid of a converter using a power semiconductor and a sensor sensing a position of a rotor and is easily controlled to be appropriate for performance required in each application.

Further, the general switched reluctance motor has a structure in which the motor and a controller are separated from each other and connected to each other by a wire. In this connection structure of the motor and controller according to the conventional art, for example, Korean Patent Publication No. 2009-0104786, the number of components is larger and an assembly process may be complicated. Therefore, a length of the motor may be increased, and a weight and a cost may be increased.

### SUMMARY

Accordingly, embodiments of the invention have been made to provide a motor assembly in which a motor and a controller may be easily connected.

According to an embodiment of the invention, a motor assembly is provided which includes a terminal provided at a stator of a motor to thereby be electrically connected to a coil wound around the stator, and a controller formed with a coupling hole to which the terminal is coupled and electrically connected and controlling electric input and output to the terminal.

According to at least one embodiment, the terminal is formed at an end portion of the stator and protrude in a direction toward the controller.

According to at least one embodiment, the terminal is formed in a pin shape.

According to at least one embodiment, the coupling hole is formed in a shape corresponding to the terminal.

According to at least one embodiment, the controller includes a printed circuit board (PCB).

According to at least one embodiment, the terminal further includes a catching part formed at an end portion thereof so as not to be separated from the controller.

According to at least one embodiment, a pair of the catching parts is formed.

According to at least one embodiment, catching protrusions protruding in a direction away from each other is formed at the pair of the catching parts.

According to at least one embodiment, the pair of the catching parts is provided in a direction parallel with each other so as to be spaced apart from each other by a predetermined interval.

According to at least one embodiment, the catching protrusion is formed in a triangular shape.

According to at least one embodiment, the catching protrusion is formed in a right triangular shape in which a width thereof is gradually decreased toward a distal end of an end portion of the catching part.

According to another embodiment of the invention, a motor assembly is provided which includes a terminal provided at a motor in order to supply driving power of the motor, and a controller formed with a coupling hole to which the terminal is coupled, to thereby be electrically connected to the terminal.

According to at least one embodiment, the terminal is electrically connected to a coil wound around a stator of the motor.

According to at least one embodiment, the terminal is formed at an end portion of a stator and protrude in a direction toward the controller.

According to at least one embodiment, the terminal is formed in a pin shape.

According to at least one embodiment, the coupling hole is formed in a shape corresponding to the terminal.

According to at least one embodiment, the controller includes a printed circuit board (PCB).

According to at least one embodiment, the terminal further includes a pair of catching parts formed at an end portion thereof so as not to be separated from the controller.

According to at least one embodiment, catching protrusions protruding in a direction away from each other are formed at the pair of the catching parts.

Various objects, advantages and features of the invention will become apparent from the following description of embodiments with reference to the accompanying drawings.

### BRIEF DESCRIPTION OF DRAWINGS:

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a front view showing a motor assembly according to an embodiment of the invention.

FIG. 2 is a separated front view showing the motor assembly according to an embodiment of the invention.

FIG. 3 is a separated perspective view showing the motor assembly according to an embodiment of the invention.

FIG. 4 is a separated perspective view showing a main part of the motor assembly according to an embodiment of the invention.

FIG. 5 is a cross-sectional view showing another example of the terminal in the motor assembly according to an embodiment of the invention.

### DETAILED DESCRIPTION:

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification.

Hereinafter, various embodiments of the present invention will be described in detail with reference to the accompanying drawings.

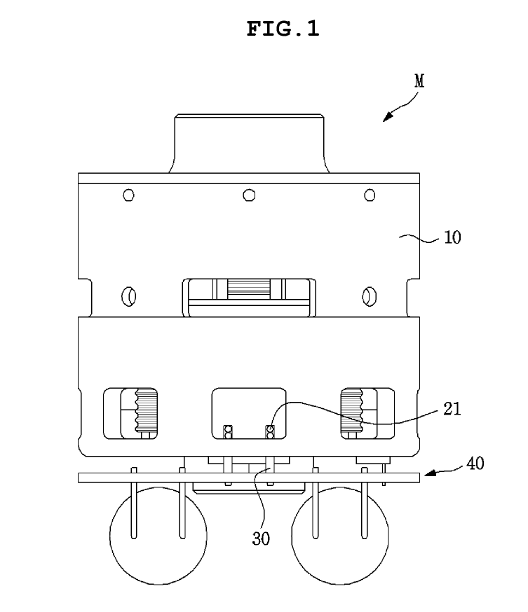

FIG. 1 is a front view showing a motor assembly according to an embodiment of the invention.

Referring to FIG. 1, the motor assembly according to an embodiment of the invention includes a terminal 30 and a controller 40.

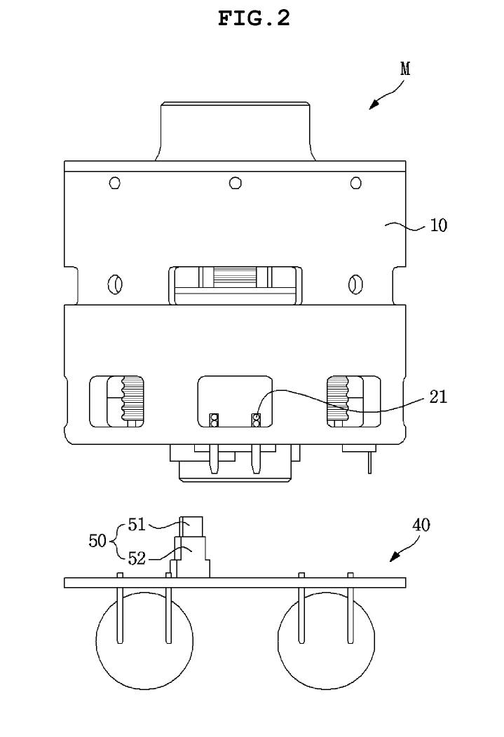

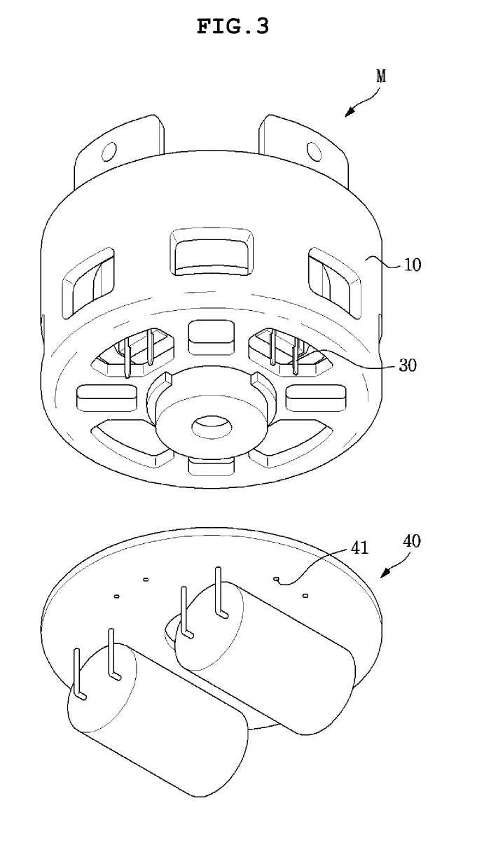

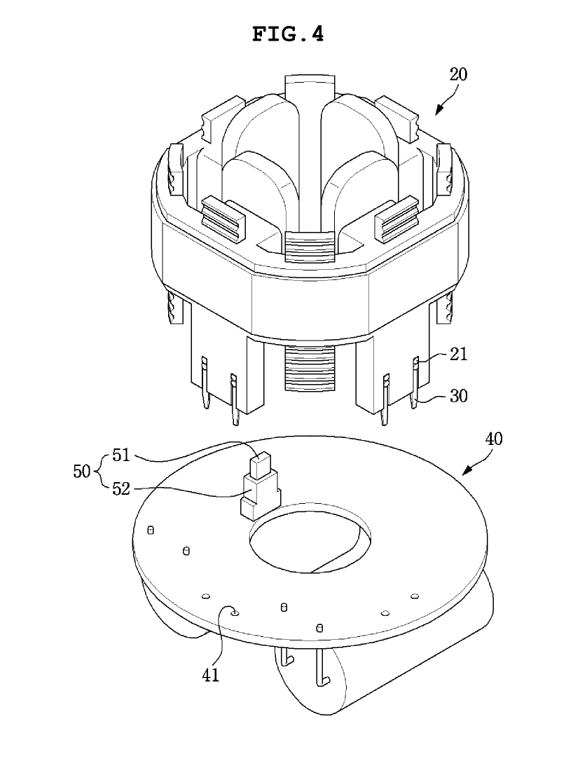

FIG. 2 is a separated front view showing the motor assembly according to an embodiment of the invention; FIG. 3 is a separated perspective view showing the motor assembly according to an embodiment of the invention; and FIG. 4 is a separated perspective view showing a main part of the motor assembly according to an embodiment of the invention.

Referring to FIGS. 1 to 4, the terminal 30 is provided at a stator 20 of a motor M to thereby be electrically connected to a coil 21 wound around the stator 20. according to an embodiment of the invention, driving power of the motor M is supplied through the terminal 30.

According to an embodiment of the invention, the motor M includeS the stator 20 having the coil 21 wound therearound, a rotor (not shown) including a rotation shaft (not shown), and a housing 10. In this case, the stator 20 and the rotor are received in the housing 10.

According to an embodiment of the invention, the terminal 30 is formed at an end portion of the stator 20 and protrudes in a direction toward the controller 40. For example, the terminal 30 protrudes in a downward direction in FIG. 2, but a protrusion direction of the terminal 30 according to an embodiment of the invention is not necessarily limited thereto.

According to an embodiment of the invention, the controller 40 is coupled to the terminal 30 and control electric input and output to the terminal 30.

In addition, coupling holes 41 to which the terminal 31 is coupled are formed in the controller 40. According to an embodiment of the invention, as an example, the coupling hole 41 is formed in a circular or tetragonal shape. In addition, as another example, the coupling hole 41 is formed in a shape corresponding to the terminal 30.

Further, the controller 40 is configured to include a printed circuit board (PCB).

According to an embodiment of the invention, a hall sensing part 50 is mounted on the controller 40. Further, the hall sensing part 50 includes a hall sensor 51 and a holder 52 to which the hall sensor 51 is coupled. According to an embodiment of the invention, the hall sensor 51 senses rotation of a magnet mounted at the rotation shaft of the motor M.

Meanwhile, as an example, the terminal is formed in a pin shape. According to an embodiment of the invention, the terminal 30 is formed in a rectangular pillar or plate shape, and an end portion thereof is formed in a tapered shape in which a width thereof is gradually decreased, but the present disclosure is not limited thereto.

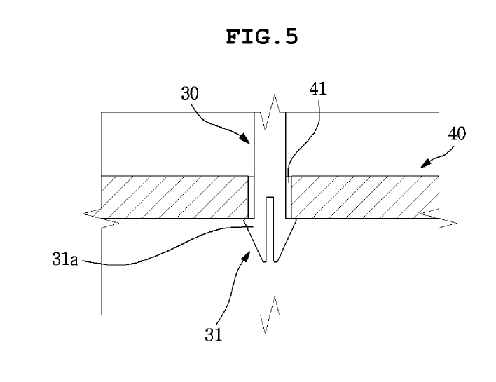

FIG. 5 is a cross-sectional view showing another example of the terminal in the motor assembly according to an embodiment of the invention.

In addition, referring to FIG. 5, as another example, the terminal 30 is formed in a hook shape. According to an embodiment of the invention, a catching part 31 is formed at the end portion of the terminal 30.

In addition, a plurality of catching parts 31 are provided and positioned in parallel with each other. For example, a pair of the catching parts 31 may be provided, but the present disclosure is not limited thereto. In this case, catching protrusions 31a protruding in a direction away from each other are formed at the pair of the catching parts 31, respectively.

According to an embodiment of the invention, the catching protrusion 31a is formed in a triangular shape. For example, the catching protrusion 31a may be formed in a right triangular shape, but the present disclosure is not limited thereto. Here, the catching protrusion 31a may be formed in a shape in which a width thereof is gradually decreased toward a distal end of an end portion of the catching part 31, such that the catching protrusion may be easily inserted into the coupling hole 41 formed in the controller 40.

According to an embodiment of the invention, a pair of the catch protrusions 31a formed at the pair of the catching parts 31 is formed to have the entire width larger than a diameter of the coupling hole 41 of the controller 40, such that the terminal 30 is not separated from the controller 40.

According to an embodiment of the invention, the pair of the catching parts 31 is extended from the end portion of the terminal 30 in a length direction to thereby be formed in parallel with each other. In this case, the pair of the catching parts 31 is formed to be spaced apart from each other by a predetermined interval. Therefore, when the terminal 30 is inserted into the coupling hole 41 of the controller 40, the pair of the catching parts 31 is bent in a direction adjacent to each other and inserted into the coupling hole 41, and then maintains their original state in which they are parallel with each other.

As set forth above, according to various embodiments of the invention, the motor assembly has the structure in which the motor and the controller is easily connected, such that the number of components is decreased, and an assembling process is simplified.

Therefore, according to various embodiments, a length of the motor is decreased, a weight thereof is decreased, and a cost is decreased.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “according to an embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. A motor assembly comprising:
a terminal provided at a stator of a motor and electrically connected to a coil wound around the stator; and
a controller formed with a coupling hole to which the terminal is coupled and electrically connected and controlling electric input and output to the terminal.

2. The motor assembly of claim 1, wherein the terminal is formed at an end portion of the stator and protrudes in a direction toward the controller.

3. The motor assembly of claim 2, wherein the terminal is formed in a pin shape.

4. The motor assembly of claim 3, wherein the coupling hole is formed in a shape corresponding to the terminal.

5. The motor assembly of claim 1, wherein the controller comprises a printed circuit board (PCB).

6. The motor assembly of claim 1, wherein the terminal further comprises a catching part formed at an end portion thereof so as not to be separated from the controller.

7. The motor assembly of claim 6, wherein a pair of the catching parts are formed.

8. The motor assembly of claim 7, wherein catching protrusions protruding in a direction away from each other are formed at the pair of the catching parts.

9. The motor assembly of claim 8, wherein the pair of the catching parts are provided in a direction parallel with each other so as to be spaced apart from each other by a predetermined interval.

10. The motor assembly of claim 9, wherein the catching protrusion is formed in a triangular shape.

11. The motor assembly of claim 9, wherein the catching protrusion is formed in a right triangular shape in which a width thereof is gradually decreased toward a distal end of an end portion of the catching part.

12. A motor assembly comprising:
a terminal provided at a motor in order to supply driving power of the motor; and
a controller formed with a coupling hole to which the terminal is coupled, to thereby be electrically connected to the terminal.

13. The motor assembly of claim 12, wherein the terminal is electrically connected to a coil wound around a stator of the motor.

14. The motor assembly of claim 13, wherein the terminal is formed at an end portion of the stator and protrudes in a direction toward the controller.

15. The motor assembly of claim 12, wherein the terminal is formed in a pin shape.

16. The motor assembly of claim 12, wherein the coupling hole is formed in a shape corresponding to the terminal.

17. The motor assembly of claim 12, wherein the controller comprises a printed circuit board (PCB).

18. The motor assembly of claim 12, wherein the terminal further comprises a pair of catching parts formed at an end portion thereof so as not to be separated from the controller.

19. The motor assembly of claim 18, wherein catching protrusions protruding in a direction away from each other are formed at the pair of the catching parts.
